(19) United States
(12) Patent Application Publication
(10) Pub. No.: US 2011/0010969 A1
(43) Pub. Date: Jan. 20, 2011

(54) APPOINTMENT CARD CALENDAR

(76) Inventors: DEBRA EINSEL MURRAY, SAN JUAN CAPISTRANO, CA (US); GARY L. MURRAY, SAN JUAN CAPISTRANO, CA (US)

Correspondence Address: LAW OFFICE OF CLAY MCGURK, P.O. BOX 6127, LAGUNA NIGUEL, CA, 92677, US

(21) Appl. No.: 12/837,718

(22) Filed: Jul. 16, 2010

Related U.S. Application Data
(60) Provisional application No. 61/226,201, filed on Jul. 16, 2009.

(51) Int. Cl. G09D 3/00

(52) U.S. Cl. 40/122

(57) ABSTRACT

An appointment card calendar is provided that includes at least one sheet with a monthly grid configuration. The sheet can be written on to indicate the year, month, and numbers of the day corresponding to a particular month. The grid configuration is arranged in rows and columns. Each day section for each day of the week has at least two slots, one AM slot and one PM slot. An appointment card can be inserted in the AM slots and PM slots for the day and corresponding time of the appointment. A hinge or binding joins two more monthly sheets together. The sheets can be successively rotated on the binding which enables each monthly sheet to be rotated to the front viewing position. The monthly sheets can have the properties of a white board, where erasable ink can be written and removed.

### CROSS-REFERENCE TO RELATED APPLICATIONS

This application claims priority to U.S. Provisional Application No. 61/226,201, filed Jul. 16, 2009, and which is incorporated herein by reference.

### BACKGROUND OF THE INVENTION

Appointment cards and business cards can be provided by anyone, including for example, doctors, dentists, psychologists, psychiatrists, and lawyers, Typically appointment cards are provided to remind their patients and clients about the details of the future appointment or meeting. Business cards usually provide information about a person or business, and contain contact information, such as addresses and phone numbers. One side of an appointment card may be the business information about the professional, including address and phone numbers. On the other side, the appointment card may include for example, the date and time of the next meeting, and the purpose of the meeting.

Once a person is provided with these appointment cards, keeping them organized can be problem, especially for a large family with multiple children or for a person having a large number of appointments. One may attach through tape, staples or paper clips to an existing paper wall calendar. Others may transfer the information to their cellular phone or other electronic planner or software, so that the appointment can be electronically tracked. The problem with electronic gadgets is that they run out of power, can be lost or stolen, or may even stop working altogether or operating correctly. Once the electronic gadget has become disabled, the ability to track and check electronically stored appointments is nearly impossible.

Therefore, what is needed is an easy to use appointment card calendar that organizes the appointment cards and makes them readily available to a user. Also what is needed is an appointment card calendar that lets a user insert the appointment card into the calendar on the day of the appointment. What is also needed is an appointment card calendar that distinguishes between AM (ante meridiem) and PM (post meridiem) appointments, so the time of the appointment can be readily ascertained.

### SUMMARY OF THE INVENTION

Accordingly, the appointment card calendar enables a user to insert an appointment card or business card into a slot for the day of the scheduled appointment. The user can then check which appointments are scheduled by retrieving the appointment cards that had been inserted into the calendar for that particular day and then check the information contained on each appointment card.

An object of the present invention is to provide an appointment card calendar that easily organizes scheduled appointments by inserting the appointment cards into a slot corresponding to the day of the appointment.

Another object of the present invention is to provide an appointment card calendar that is economical to manufacture and easy to use.

Another object of the present invention is to provide an appointment card calendar that provides a quick way for referring to the appointments that have been scheduled during a particular month.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed and not to limit it.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 illustrates a front view of one month of an appointment card calendar according to a preferred embodiment of the present invention.

FIG. 2 illustrates a front sheet, a back sheet and adhesive for one monthly sheet of an appointment card calendar according to a preferred embodiment of the present invention.

FIG. 3 illustrates a bar for an appointment card calendar according to a preferred embodiment of the present invention.

### DETAILED DESCRIPTION OF THE PREFERRED EMBODIMENT

Reference will now be made in detail to the preferred embodiments of the present invention, examples of which are illustrated in the accompanying drawings.

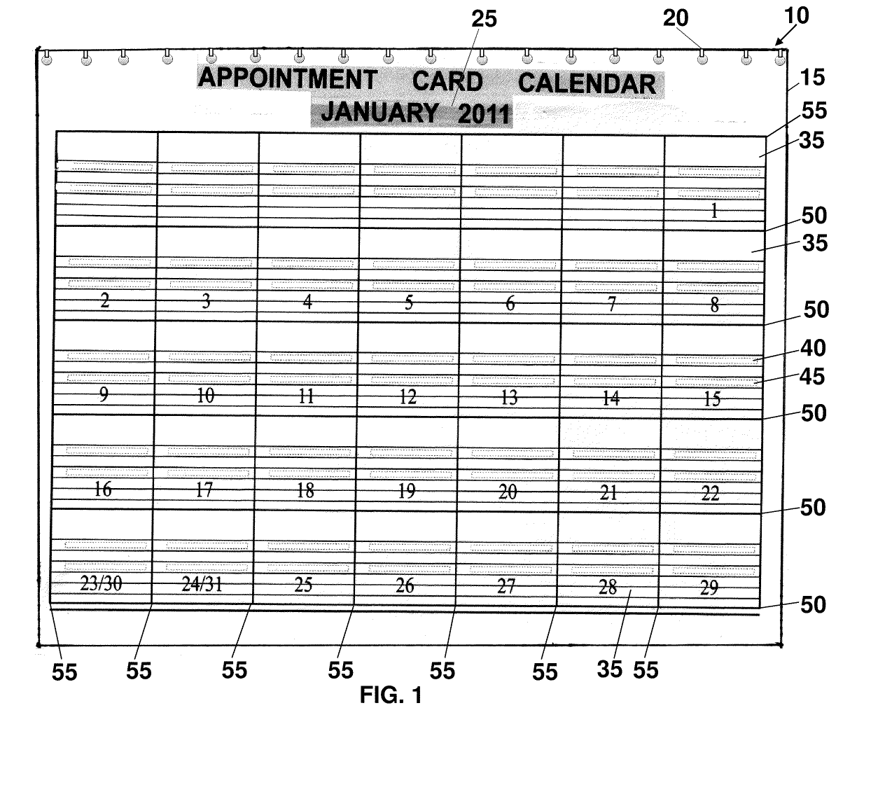

FIG. 1 illustrates a front view of one month of an appointment card calendar 10 according to a preferred embodiment of the present invention. An appointment card calendar 10 comprises one or more monthly calendar sheets 15 attached together using spiral binding or hinge 20. Although calendar 10 is preferred to be arranged according to the traditional monthly arrangement, other calendar sheet 15 embodiments may include time periods of one or more weeks, one or more months, or a year. Each monthly sheet 15 is comprised of two sheets of paper which are joined together. Each sheet 15 can be constructed of a material which includes, but is not limited to, canvas, cotton, plastic, or any other suitable material. The front and back sheet can be made of the same material or can have a different material. The material is substantially planar so that it can be hung on a wall or laid on a table. In the preferred embodiment, the front sheet 15 of calendar 10 has an erasable surface that performs similar to a white board.

A whiteboard is also known as a wipe board, marker board, dry erase board, dry wipe board or a pen board. Whiteboard is a name for any glossy surface, most commonly colored white, where non-permanent markings can be made. Whiteboards operate analogously to chalk boards in that they allow markings to temporarily adhere to the surface of the board. Hard-coat laminate and melamine (a resin-impregnated paper which is typically used over a pressboard substrate) are two types of materials that can be used on the front sheet 15 of calendar 10. In the preferred embodiment, a hard-coat laminate is used.

Each monthly sheet 15 of calendar 10 are joined together to other monthly sheets 15 of calendar 10 via a spiral binding 20. Calendar 10 is preferred spiral-bound, meaning that a spiral of wire is looped through large perforations at the top or side of the sheet 15 of calendar 10. Other binding devices and methods could be used as well including rings, rods, discs, or other hinges. In each of these systems, the sheets 15 are modified with perforations that facilitate the specific binding mechanism's ability to secure them. Ring-bound and rod-bound calendars 10 secure the sheets 15 by threading perforated sheets 15 around straight or curved prongs. In the open position, the sheets 15 can be removed and re-arranged. In the closed position, the sheets 15 are kept in order. Disc-bound calendars 10 remove the open or closed operation by modifying the pages themselves. A sheet 15 perforated for a disc-bound binding calendar 10 contains a row of teeth along the side edge of the sheet 15 that grip onto the outside raised perimeter of individual discs. Sheets 15 can be added or removed at any time by peeling the perforations away from each disc.

The sheet 15 corresponding to January 2011 is shown as an example in FIG. 1. In the preferred embodiment, there is a monthly calendar sheet 15 for each month for an entire year, i.e., January through December. In alternative embodiments, there may be only one or more monthly sheet 15 for the entire year. For example, there may be one erasable sheet 15 that is used for the entire year. In this configuration, erasable sheet 15 does not have the month or days printed on the sheet 15, but have sections where the month or number of the days can be filled-in. A person is able to write the day and months on the calendar and then erase them, and fill-in the new month and day configuration for the next months. It is even contemplated that a person can have two months going concurrently on the same sheet 15, so that when a day concludes, that day can be erased and the corresponding day for the next sequential month can be filled-in. In another example, three erasable sheets 15 may be used for the entire year. A person can write the day numbers and name of the months for three consecutive months on the sheets 15, giving the ability to track appointments for three consecutive months. Using the spiral binding, once a month concludes, the sheet 15 of the concluded month can be erased, the month and numbers of the days of the third month can be written on the calendar, and then the sheet can be rotated on the spiral hinge 20 to become the last sheet 15 of the calendar 10. For example, as shown on FIG. 1, “January” and the numbers corresponding to the days could be erased, and “April” and the numbers of the days corresponding to “April” could be filled-in on an erasable calendar sheet 15.

FIG. 1 illustrates a non-limiting example of a monthly calendar and includes a plurality of time period sections. These time period sections include, but are not limited to, a year/month section 25 and a day grid 30. Day grid 30 is comprised of day sections 35, where each of the day sections 35 has an AM section 40 and a PM section 45. Year/month section 25 at the top of sheet 15 is where the month and year are displayed. In the preferred embodiment, section 25 is printed with the month and year. However, in alternative embodiments, section 25 could be left blank on an erasable, white-board sheet 15. This gives the ability to write the month on the top of sheet 15, which can be erased when another month is desired. Section 25 can also be replaceable with a preprinted strip that displays either the month and year, or just the month. The strip may be adhered to the calendar by a variety of means, including for example, magnets or a low-tack, re-adherable strip of adhesive on the back of the strip, designed for temporarily attaching the strip to sheet 15. Although section 25 is used for displaying the year and month as shown in FIG. 1, it will be appreciated that two sections can be used, one section used for displaying the month, and another section used for displaying the year. These two sections may be either joined or separate, and can have a border of varied colors surrounding each of the sections.

As shown in FIG. 1, day grid 30 has day sections 35 arranged in a table or grid arrangement. The names for the days of the weeks are generally located at the top or the bottom of the grid on sheet 15. There are five rows and seven columns of day sections 35, for a total of thirty-five day sections 35. Although five rows are used, it will be appreciated that four rows could be used as well, for a total of 28 day sections. If four rows were used, day “1” and day “8” could be combined into the same day section 35, similar to the combination of days “23/30” and “24/31” as shown on FIG. 1. The number for each of the days are sequentially numbered for that particular month. As discussed above, on a erasable whiteboard sheet 15, the number of the days can be written on sheet 15 using erasable ink.

Each day section 35 of day grid 30 has an AM section 40 and a PM section 45. Each of the AM sections 40 and PM sections 45 has at least one slit, cut, opening, or slot. Each of the slots is where an appointment card can be inserted into the calendar 10. Each slot can hold multiple appointment cards or business cards. A portion of the appointment card will be visible when inserted into a slot in calendar 10. In the preferred embodiment, the appointment card will not cover the number of the day associated with the day section above it. For example, when an appointment card is inserted into the AM section or PM section associated with day “12”, the appointment card will not cover the day number “5”, which is the day section directly above the day section “12”. However, if calendar 10 is made smaller, meaning the day sections 35 are made smaller, it will be appreciated that when an appointment card is inserted into the slot, the appointment card may cover numbers above or below

As shown in FIG. 1, there is one slot, slit or opening in sheet 15 for each of the AM sections 40 and PM sections 45. The slot is at least as large as a business card or appointment card. The slot has an opening in sheet 15 whereby a business card or appointment card can be inserted therein. A portion of the appointment card will stick-out or protrude from calendar 10, while another portion will be held inside a day section 35 of calendar 10. In other words, each day section 35 has a pocket or ledge where the appointment card can be inserted. The AM section 40 and PM section 45 of each day section 45 use the same pocket. The bottom of the day section 35 is oriented with respect to the AM section 40 and PM section 45 so that when the appointment card reaches the bottom of the pocket or ledge, the appointment card will protrude upwardly through the slot on the front of calendar 10. The appointment card or business card can then be readily manually removed when desired.

In the preferred embodiment, a pocket is formed in each day section 35 by an adhesive that runs along the bottom and sides of each of the day sections 35. This adhesive is found on the back side of the front sheet 15, and the front side of the back sheet, and is where the front sheet 15 attaches to the back sheet 15. The adhesive runs along bottom of each row 50 and column 55 of grid 30. There are a vast number of adhesives that could be used for joining the front and back sheets together, but a typical adhesive that can be used is glue or two-sided tape. By having the adhesive join the two sheets together, this forms a pocket or ledge for each day section 35. The appointment card can then be inserted through AM section 40 or PM section 45. An edge of the appointment card will stop and rest at the bottom of the row 50 where the adhesive is located. In an alternative embodiment, an adhesive could be used on the rows 50 only. An adhesive would not be used or placed on columns 55.

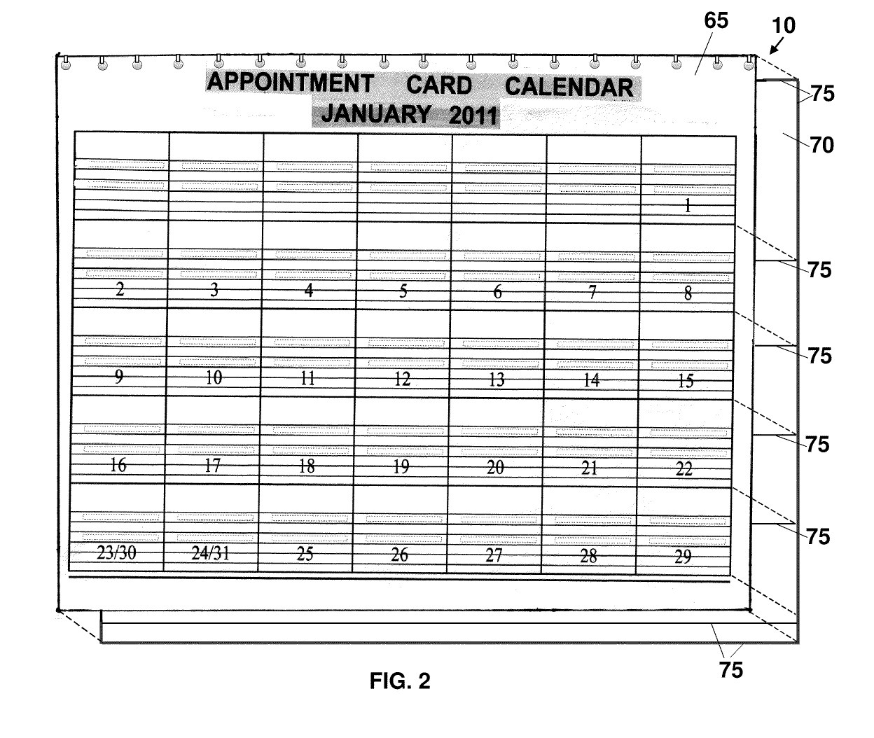

FIG. 2 illustrates a front sheet 65, a back sheet 70 and adhesive 75 for one monthly sheet 15 of an appointment card calendar according to a preferred embodiment of the present invention. The front sheet 65 would align with the back sheet 70 along the dotted lines shown in FIG. 2. The adhesive 75 runs along a plurality of rows (of day grid 30) and the edge of back sheet 70. Adhesive 75 would hold the front sheet 65 to the back sheet 70 and, when held together, forms the pockets or ledges described above for each of the day sections 35.

Instead of using one slot for each of the AM sections 40 and PM sections 45, two slits or openings in sheet 15 could be alternatively used for each of the AM sections 40 and for each of the PM section 45. When two slits are used for AM sections 40 and PM sections 45, an appointment card can alternatively be placed between the two slits instead of being inserted into the pocket of the day section 35. This means that the appointment card will not be inserted into a pocket into the calendar 10, but instead will be held onto the front of calendar 10 by the piece of material that is formed between the two slits formed by sheet 15.

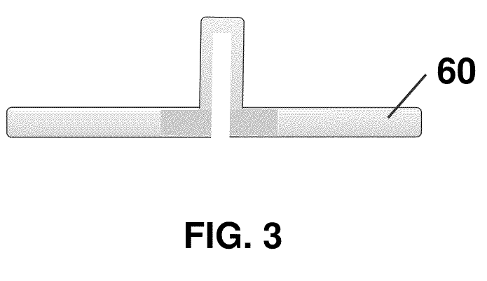

The calendar 10 can be attached to a wall or door by hanging the calendar 10 using an bar 60 as shown in FIG. 3. Bar 60 fits inside spiral binding 20, where the hook or loop fits between two rings of the spiral binding 20. The hook can be placed on nail, screw, or other appropriate mechanism for hanging the calendar 10 on the wall or similar vertical structure.

Particular embodiments of the present invention have been shown and described, and it will be understood that it is not intended to limit the present invention to the preferred embodiments. It will be obvious to those skilled in the art that various changes and modifications may be made without departing from the spirit and scope of the present invention. Thus, the present invention is intended to cover alternatives, modifications and equivalents, which may be included within the spirit and scope of the present invention as defined herein. For example, the calendar and AM sections 40 and PM sections 45 are oriented in the vertical direction, meaning that appointment cards are inserted in the vertical direction. However, in alternative embodiments, the AM sections 40 and PM sections 45 could be oriented in the horizontal direction, so that appointment cards can be easily read and are insertable in the horizontal plane or direction. Pockets for each of the day sections 35 would be formed along the columns 55 instead of the rows 50 (FIG. 1).

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. A calendar comprising:
at least one sheet having a front portion and a back portion, each of the sheets having a plurality of day sections;
a plurality of pockets formed between the front portion and the back portion; and
each day section including an AM slot and a PM slot, wherein the AM slot and the PM slot form two openings in a pocket associated with each day section.

2. The calendar of claim 1, further comprising binding to hold one or more sheets together, the binding permitting each of the sheets to be rotatable on the binding.

3. The calendar of claim 2, further comprising a bar that fits inside the binding.

4. The calendar of claim 1, wherein each sheet has the plurality of day sections formed into rows and columns, and wherein an adhesive joins the front portion and the back portion along the rows.

5. The calendar of claim 1, wherein each sheet has the plurality of day sections formed into rows and columns, and wherein an adhesive joins the front portion and the back portion along the rows and columns.

6. The calendar of claim 1, wherein a front portion of each sheet is made of laminated paper.

7. The calendar of claim 1, wherein a front portion of each sheet is made of plastic.

8. The calendar of claim 1, wherein a front portion of each sheet is made of a material where erasable ink can be applied and removed.

9. A calendar comprising:
a plurality of sheets, each sheet having a front portion and a back portion and a plurality of day sections;
a plurality of pockets formed between the front portion and the back portion on each of the sheets; and
each day section including an AM slot and a PM slot, wherein the AM slot and the PM slot form two openings in a pocket associated with each day section.

10. The calendar of claim 9, further comprising binding to hold one or more sheets together, the binding permitting each of the sheets to be rotatable on the binding.
